(19) United States
(12) Patent Application Publication
(10) Pub. No.: US 2018/0063464 A1
(43) Pub. Date: Mar. 1, 2018

(54) Switch UPS floor lamp cover and TV frame cover

(71) Applicant: Leola Brantley, Rochester, NY (US)

(72) Inventor: Leola Brantley, Rochester, NY (US)

(21) Appl. No.: 15/330,265

(22) Filed: Aug. 25, 2016

(51) Int. Cl. H04N 5/64; F21V 1/14

(52) U.S. Cl. CPC H04N 5/64; F21V 1/146

(57) ABSTRACT

Uniqueness: Lightweight plastic money saver with or without legs; slips over old floor lamps to refurbish or change the look of a new lamp. An aid to those with a small income or just like or want a change in décor. A snap on and off Television Frame Cover offering uniqueness, frames the television, and can come in many colors, which can match your home décor.

### CROSS-REFERENCE TO RELATED APPLICATIONS

This application claims benefit of Provisional Application 62/388,721 filed Feb. 5, 2016.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND OF THE INVENTION

### (1) Field of the Invention

The present invention relates to a device that relinquishes the problem of purchasing new floor lamps. Also described is a sensible inexpensive way to remodel television frames for a unique look.

### (2) Description of Related Art Including Information Disclosed Under 37 CFR 1.97 and 1.98

Not Applicable

### BRIEF SUMMARY OF THE INVENTION

The invention is a sensible inexpensive way to restore old floor lamps or give new floor lamps a different look. The present invention comprises a system for efficiency. One embodiment of the system comprises diversity.

The lamp cover is designed in glass or plastic, clear, frosted or colors. The lamp shade cover inexpensively changes features or aesthetics of old, existing or new floor lamps. The floor lamp will be constructed as a one piece, in glass and plastics that will be clear, frosted, one or many colors, and made of other finished naturally colored elements that will be developed into lightweight materials. Like exterior body, the shapes curves and lines will flow smoothly. Heated machinery, hand tools, glass and plastics will be used and professionally formed from my diagrams, drawings, and supervision. In a second embodiment a system for remodeling television frames for a unique look is described. The television frame is designed to change features or aesthetics of old, existing, or new television.

### BRIEF DESCRIPTION OF THE SEVERAL VIEWS OF THE DRAWING(S)

FIG. 1 shows: Front view of floor lamp cover.

FIG. 2 shows the TV Cover.

### DETAILED DESCRIPTION OF THE INVENTION

In the first embodiment a Removable covering for floor lamps is described wherein the lamp shade cover is a lightweight material allows sliding over existing or new floor lamp to change appearance. The level square bottom can also stand-alone or with legs, and used in many ways dependent on individual discretion. The Floor lamp cover will vary depending on style and height of floor lamp itself, but estimated to be approximately 5½ ft. H×1½ ft. W, with hollow opening to cover lamp. Various other objects, features and advantages of the present invention will become fully appreciated as the same becomes better understood when considered in conjunction with the accompanying drawing in which like reference characters designate the same or similar parts throughout the view.

In the second embodiment, the television frames can be of various widths and includes snap on sides. Flexible plastic and rubber can be used and can be clear, frosted, designed in colors and mad of other finished naturally colored elements that will be developed into lightweight material. The television ram cover will be constructed as one piece, in plastic or in rubber that will be of one or plural colors, and made of other finished naturally colored elements that will be developed into lightweight material. Like exterior body's flat surface, the shapes curves and lines will flow smoothly. Heated machinery, hand tools, plastic and rubber will be used to provide the TV cover as shown in the drawings.

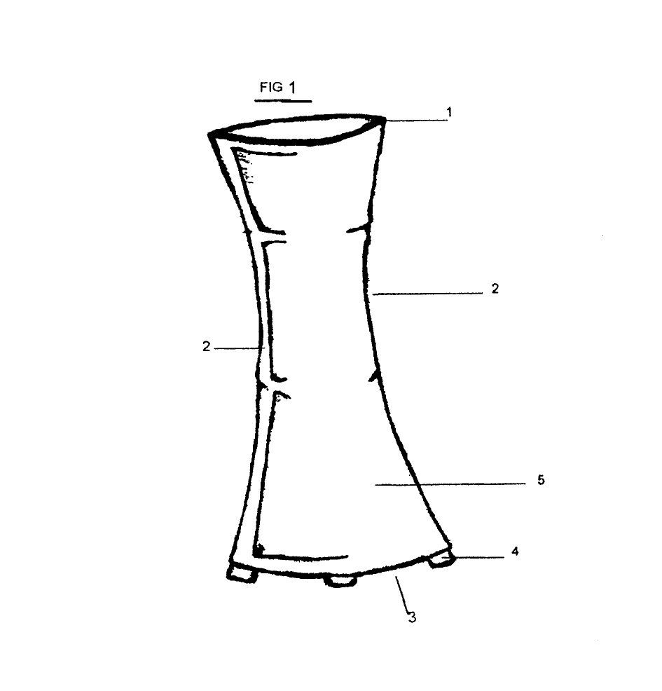

### FIG. 1 Floor Lamp Cover

1. Element 1 shows top of lamp cover

2. Element 2 shows sides of lamp cover

3. Element 3 shows bottom of lamp cover

4. Element 4 shows legs of lamp cover

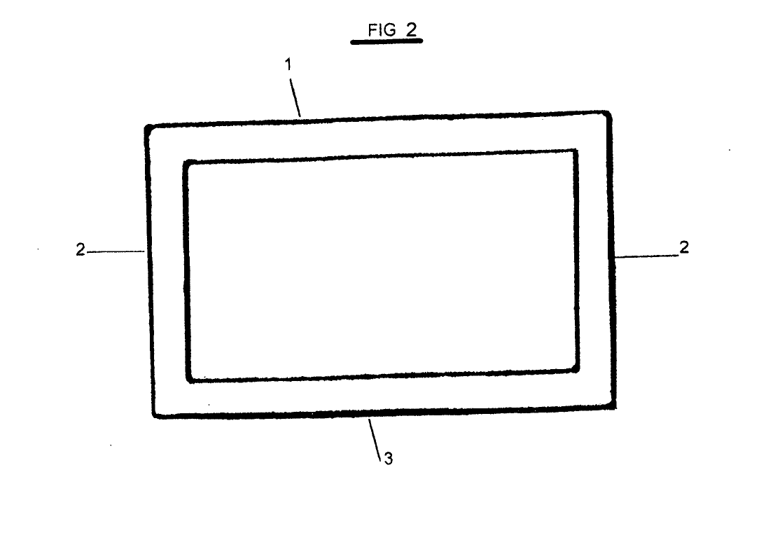

### FIG. 2 TV Frame Cover

1. Element 1 shows top of frame cover

2. Element 2 shows sides of frame cover

3. Element 3 shows bottom of frame cover

What is claimed is:

1. A floor lamp cover comprised of: Lightweight durable glass or plastic, clear, frosted or colors, etc, floor lamp cover according to claim #1, lightweight material allows sliding over existing or new floor lamp to change appearance. The wide level bottom can have legs or stand-alone and can be used in many ways dependent on individual discretion. Constructed for aesthetics, convenience, and economics.

2. What is claimed is: TV Frame Cover comprised of flexible rubber or snap-on plastic, plural sizes, lengths, and shapes. TV frame cover according to claim #2, is flexible rubber or snap-on plastic. TV frame designed to change color of television frames for new look. Constructed for aesthetics, convenience, and economics.
